(19) United States
(12) Patent Application Publication
(10) Pub. No.: US 2010/0170982 A1
(43) Pub. Date: Jul. 8, 2010

(54) Aircraft without pilot (for commercial and military use)

(76) Inventor: Ruchit Kumar Regmi, Kathmandu (NP)

Correspondence Address: Ruchit Kumar Regmi, P O Box #23890, Kathmandu, NP

(21) Appl. No.: 12/378,025

(22) Filed: Jan. 6, 2009

(51) Int. Cl. B64C 19/00; G01S 13/93

(52) U.S. Cl. 244/75.1; 342/29

(57) ABSTRACT

My innovated aircraft doesn't need pilots to fly in the designated airport; rather, it needs air worthy aircraft and airport's communication/navigation systems. By responding with the communication/navigation system of the airport and inbuilt system of my innovated aircraft, it can do all the jobs of the present aircraft but without requiring any pilot to fly. Therefore, aircraft accident due to pilot error, hijacking etc can be controlled on the aircraft and air transport will be safer than that of present aircraft.

A. 1) Traffic Collision Avoiding
2) Aircraft route following—In Software package or in electronic form.
   a) In—Cruise
   b) In turbulence and other disturbance
   c) In emergency
   d) Alternate route following
3) Aircraft during landing
4) Aircraft after Landing
5) Aircraft During Pushback
6) Aircraft During Take off
7) Aircraft During Start Up and Switch Off

B) Communication and navigation aids of Aircraft

A. 1) Traffic Collision Avoiding:
Traffic Collision avoiding is done just like by TCAS on present aircraft. In Present aircraft TCAS is installed to alert in UP/Down traffic. But in my invention forward and backward traffic collision sensing, alerting and avoiding also can be done considering for future's increase in air-transportation (In future only vertical separation may be insufficient). Up/Down and Backward/Forward traffic collision Avoiding system is just like in present TCAS system, It can be used by:
   Sensing Up/Down and Forward/Backward traffic and alerting if another traffic is less than the separation limit.

Alerting and correcting own aircraft path is done simultaneously by

a) increasing/decreasing Lift

b) increasing/decreasing Speed

a) To increase /Decease lift: Sensing elements are installed at Ailerons, Elevators, Rudders and at other flight controls. The Sensing elements Sense the direction, deviation/angle of flight Controls. If Aircraft has to change height then senses the required angle difference of the flight controls to the new required path and then matches the angle/deviation of flight controls for the desired path and then corrects the angle/deviation of flight controls by feedback loop.

Synchronization is done with the sense elements and corrected elements to reduce the time delays and to increase efficiencies and correctness.

Alerting/Alarming and indication system can be built and installed.

b) To increase/decrease Speed: Senses the forward/Backward Aircraft
If Speed has to be increased/decreased because of the other nearer aircraft:
A) tally/compare the distance between aircraft and own present aircraft speed and finds the required desired speed.

If Speed has to be controlled then controls the speed by controlling the fueling including auto throttle/Power Lever, Air-Intake, fan blade Speed/size/and angle automatically by using sensors, feedback loop and automatic controller.

Synchronization system can also be built.

2). Aircraft Route Following:

Software can be built/developed for the desired route's path including its elevation/attitude indication (display) and airport's elevation/attitude.

In case of emergency landing in alternate airport, the probable and alternate airport's route following software has to be attached and can be made active (by automatic engaging/disengaging system) while required. Aircraft Route Following can also be either in software package or in electronic form.

During alternate airport approach: Communicating/navigating with the alternate airport's communication/navigation system by sensing and automatic monitoring and auto decision making by using programmed essential limited range of parameter of the components and by using feed back signal processing with the communication/navigation system of the alternate airport; and with the aircraft's communication navigation, controlling and monitoring system.

In turbulence and Disturbances (Including in Minor Snags):

Sensing/indicating the severity of snags and turbulences and monitoring and controlling them by adjusting flight control system. All the jobs are done automatically.

Severity of Snags Sensing System: If snag is minor then connecting (engaging)/disconnecting (disengaging) the required system if necessary and automatically uses the alternate and standby system. Level of snag (i.e. minor, major, cautious and emergency) can be differentiate by using/reading (sensing) the parameter of the component/equipment and the normal, caution, danger/emergency range of the parameter could be determined from the programmed software and or electronic circuits. If snag is major and has to take for immediate action then senses and prepares for emergency landing system. For the purpose senses the current aircraft position, type of snag, enabling/disenabling the required system and then follows the same system as in case of emergency landing. For that purposes software and electronic sensing and control system can be used.

3). Aircraft During Landing:

Normal process just like in present auto pilot system and for contacting communication/navigation system of airport, sensing/control unit can be used and monitors all the required parameters.

4). After Landing:

Towing aircrafts in the required bay. In bay, signaling system has to be in such that signal could be sensed and monitored by aircraft (that means electronic signaling system)

5). During Pushback:

By following bay signal and airport runway/taxiway signals. Here is also sensing/controlling (monitoring) system are used.

6). During Take Off:

Monitors/senses the required aircraft parameters and controls by using sensors and feedback systems and also senses/monitors communication/navigation system of airport at the same way.

7). Start Up And Switch Off System:

Starts up by signal transmission from communication/navigation aids of airport after all door closed. All door closed signal has to be transferred/transmitted and sensed by communication/navigation system of airport.

Switch Off system : Either certain time limit after all door closed and no start up signal till that time and or by ground engineer.

B). Communication/Navigation aids of Airport:

Airports communication/navigation system has to be modernized and to be used in such a way that can be sensed by the aircraft and that can also sense/response the aircraft's sensing system and aircraft's location automatically and sense signal about all the conditions/locations and meteorological parameters and or data of airport and its following paths.

Communication (Air Traffic Control) system will be better either by computer controlled/operated or by electronically than by manually (by A.T.C). Air safety will also be better than present type air transport by avoiding human mistakes.

1) Civil Aircraft

2) Military Aircraft
